(19) United States
(12) Patent Application Publication
(10) Pub. No.: US 2009/0016152 A1
(43) Pub. Date: Jan. 15, 2009

(54) Particulate collector for mixing container

(76) Inventor: Joel S. Beaton, Horseheads, NY (US)

Correspondence Address: David Giglio, Esq., 231 Elizabeth Street, Utica, NY, 13501, US

(21) Appl. No.: 11/978,035

(22) Filed: Oct. 29, 2007

Related U.S. Application Data
(63) Continuation-in-part of application No. 11/827,071, filed on Jul. 11, 2007.

(51) Int. Cl. B01F 13/06

(52) U.S. Cl. 366/139

(57) ABSTRACT

The present invention provides a particulate collection apparatus for use in mixing powdery substances such as mortar and grout into a paste like workable compound. The particulate collection apparatus engages a top surface of a mixing container. The particulate collection apparatus includes a plurality of equidistant spaced openings, preferably along its top surface which extend into a hollowed member. The hollowed member further includes an exteriorly situate opening which mates with a vacuum hose. As such the vacuum creates a downward draft that draws billowing particulates through the hollowed member and into a vacuum storage container.

The present invention is a continuation in part application from the same inventor Ser. No. 11/827,071 which bears a filing date of Jul. 11, 2007 for which the benefit of the earlier priority date is herewith claimed under 35 USC 120.

### FIELD OF THE INVENTION

The present invention relates generally to the field of masonry and, more particularly, to the field of mixing mortar and grout in a mixing container.

### BACKGROUND OF THE INVENTION

In the tile setting and masonry trades it is always necessary to mix mortar and grouts for installation and replacement of tiles, bricks and the like. Mortar and grout are typically made by mixing powdery compound with a sufficient amount of water to create a paste like substance. The paste like substance is then applied with a trowel or other tool either to secure the tile or brick or to fill in a gap between the same.

The mixing typically takes place in a portable container, such as a five gallon bucket. The user first pours the powdery compound into the bucket and then adds water and stirs the mixture.

Several problems arise during the mixing process. First when pouring the powder into the container, powder particulate billows out and creates a mess. Worse yet the powder is physically harmful when breathed in. For installers, who work with the mortar and grout on a routine basis it is often necessary to wear a particulate mask when mixing the compound.

Even after the particulate settles, more particulate is created when mixing the compound as the powder is turned over and over to join with the water.

### SUMMARY AND OBJECTS OF THE INVENTION

It is an object of the present invention to improve the field of tile setting and masonry.

It is another object of the present invention to make it safer for workers who mix masonry compounds.

It is a further object of the present invention to keep work sites cleaner when mixing masonry compounds.

It is a feature of the present invention to provide a mixing container which makes it safer for workers working with masonry compounds.

It is another feature of the present invention to provide a mixing container which assists a mason in keeping his work site clean.

It is yet another feature of the present invention to provide a mixing container which cooperates with a vacuum system to prevent masonry particulate from billowing from the mixing container during the mixing process.

These and other objects and features are provided in accordance with the present invention in which a particulate collection apparatus prevents the billowing spillover from a mortar and grout mixing container. The apparatus includes an upper member which engages a top surface of a mixing container.

The present invention provides a particulate collection apparatus for use in mixing powdery substances such as mortar and grout into a paste like workable compound. The particulate collection apparatus engages a top surface of a mixing container. The particulate collection apparatus includes a plurality of equidistant spaced openings, preferably along its top surface which extend into a hollowed chamber. The hollowed chamber further includes an exteriorly situate opening which mates with a vacuum hose. As such the vacuum creates a downward draft that draws billowing particulates through the hollowed chamber and into a vacuum storage container.

### BRIEF DESCRIPTION OF THE DRAWINGS

The present invention will be understood and appreciated more fully from the following detailed description taken in conjunction with the drawings in which:

FIG. 1 is a perspective view of a particulate collection apparatus in conjunction with a mixing container and vacuum device in accordance with a preferred embodiment of the present invention;

FIG. 2 is a cross sectional side elevation view of the particulate collection apparatus of FIG. 1;

FIG. 3 is a cross sectional side elevation view of the particulate collection apparatus of FIG. 3 in use with a mixing container;

FIG. 4 is a top view of the particulate collection apparatus of FIG. 1 depicting a plurality of spaced opening in a top surface of an upper member;

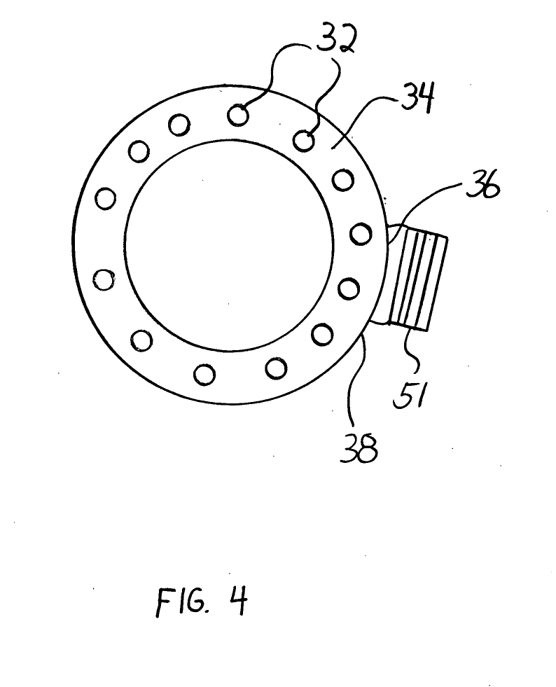

FIG. 5 is a side elevational view of an alternative embodiment of a particulate collection apparatus;

FIG. 6 is top view of an alternative embodiment of a particulate collection apparatus of the present invention;

FIG. 7 is a cross sectional side elevation view of the particulate collection apparatus of FIG. 6; and

FIG. 8 is a top perspective view of another alternative embodiment of a particulate collection apparatus of the present invention.

### DETAILED DESCRIPTION OF THE PRESENT INVENTION

The present invention will now be described in accordance with a preferred embodiment. As will become apparent to one skilled in the art many modifications, different shapes and sizes and different materials all lie within the spirit and scope of the present invention.

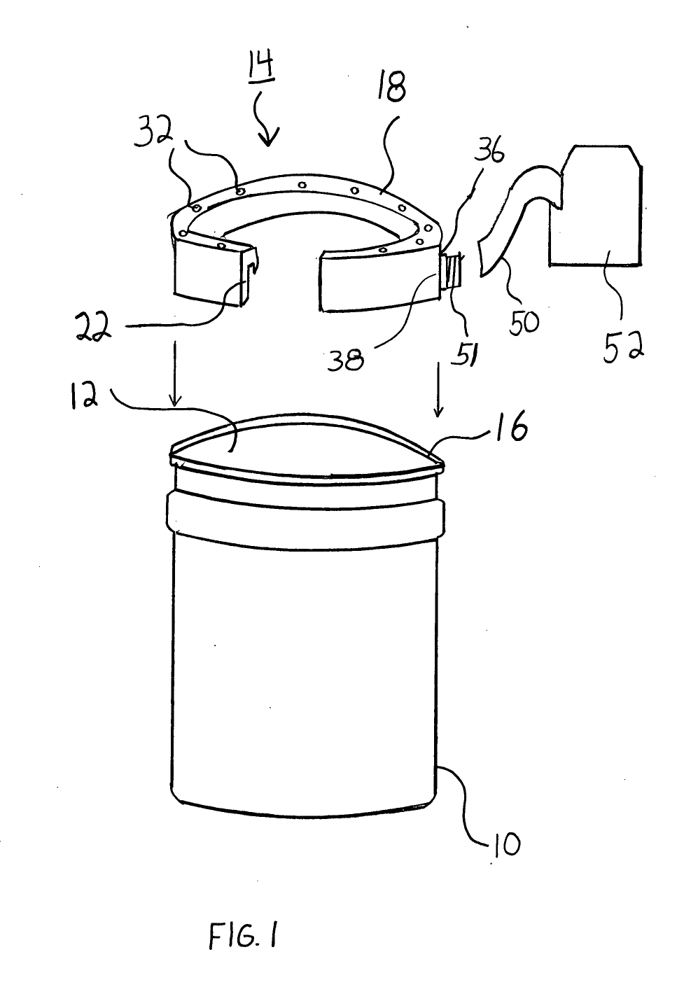

Turning now to FIG. 1, there is depicted a five gallon mixing container 10 which is often used to mix various masonry compounds such as mortar and grout. The five gallon mixing container 10 includes an interior surface 12 in which mixing is accomplished.

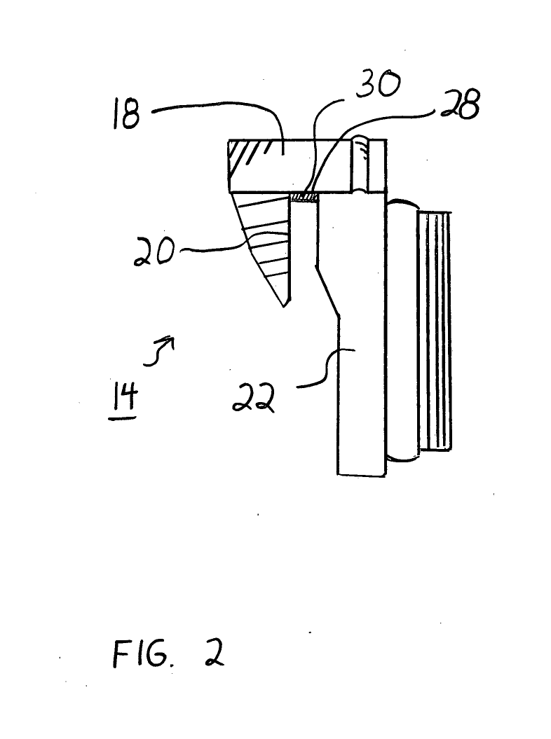

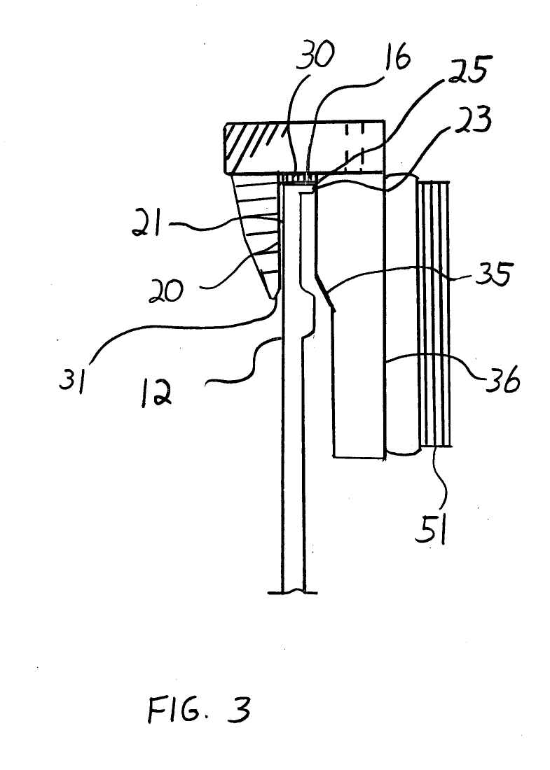

An annular particulate collecting ring 14, depicted in FIGS. 2 and 3, engages with a top annular surface 16 of the five gallon mixing container 10. In order to engage the top annular surface 16, the annular particulate collecting ring 14 includes a top annular member 18, an inner annular flange 20 which extends downwardly from the top annular member 18, and an outer annular chamber 22 which also extends downward from the top annular member 18.

A beveled edge 31 on the inner annular flange 20 and a beveled edge 35 on the inner annular surface 23 of the outer annular chamber 22 guides the top annular surface 16 of the mixing container 10 upward toward the sealing o-ring 30.

An underside 28 of the top annular member 18 includes a rubberized o-ring 30 which lies on top of the top annular surface 16 of the five gallon mixing container 10. The rubberized o-ring 30 prevents particulates from passing from the interior of the five gallon mixing container 10 and under the outer annular chamber 22.

Shown as installed in FIG. 3, the o-ring 30 sets directly on the top annular surface 16 thereby forming a seal there between. The inner annular flange 20 preferably fits against a top portion 21 of the interior surface 12 of the five gallon mixing container. The outer annular chamber 22 includes an inner annular surface 23 which preferably fits against an outer surface portion 25 of the five gallon mixing container 10.

The annular particulate collecting ring 14 includes a number of evenly spaced openings 32 in a top surface 34. The openings 32 communicate with the outer annular chamber 22 which is preferably hollowed.

The outer annular chamber 22 further includes an opening 36 in an outer surface 38 which terminates at a vacuum port 51, which is sized to accommodate a standardized shop vacuum hose 50.

In operation, the user pours the powdery mixing compound (not shown) into the five gallon mixing container 10. As typically will happen, the dust billows out over the top annular surface 16 of the five gallon mixing container 10.

However, when the shop vacuum is activated, a downdraft is created through the openings 32. The particulates that were billowing over the five gallon mixing container 10 are now sucked through the openings 32 due to the downdraft. As the particulates accumulate in the outer annular chamber 22 they are sucked through the vacuum hose 50 and safely into a vacuum container 52.

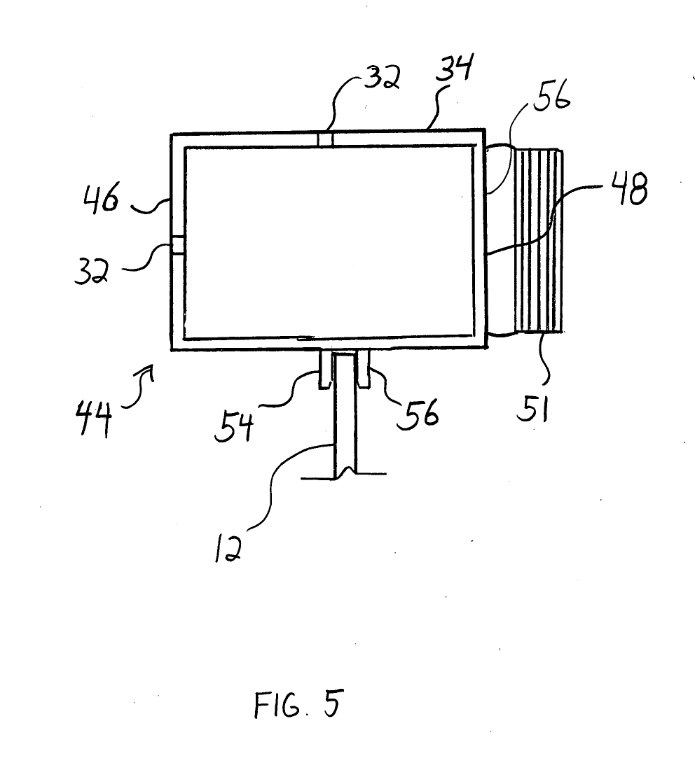

Turning now to FIG. 5, an annular particulate collecting ring 44 includes a pair of connecting clips 54, 56 which secures the collecting ring 44 to the mixing container 10. The openings 32 are placed either/or both at the top surface 34 or at an interior surface 46. Once again, the opening 56 and connector 51 are disposed at an outer surface 48 of the annular particulate collecting ring 44.

In a preferred embodiment, the annular particulate collecting ring 14 is made of a plastic or other suitable material and includes a minimum thickness of 90 mil. The annular particulate collecting ring 14 should be of a suitable dimension to communicate with the mixing container 12 as described herein.

It is readily understood that mixing containers come in various shapes and sizes. For example, a mixing container may be rectangular shaped. In that situation, the particulate collecting ring must be shaped to accommodate the top surface of the mixing container, or in that example may be rectangular shaped.

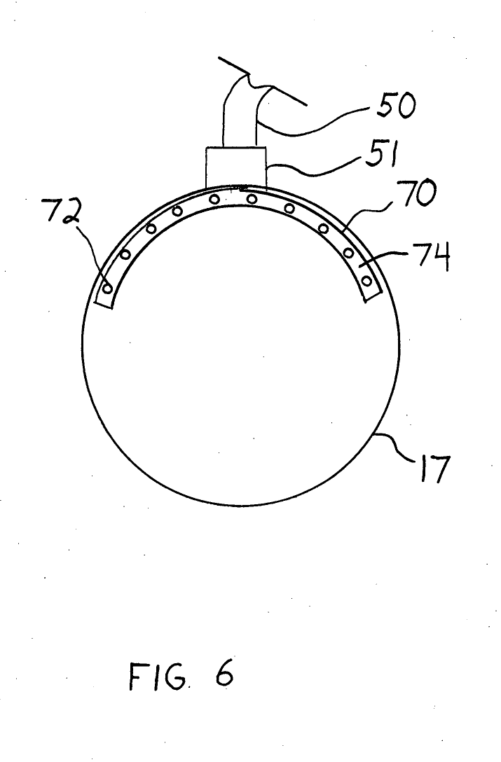

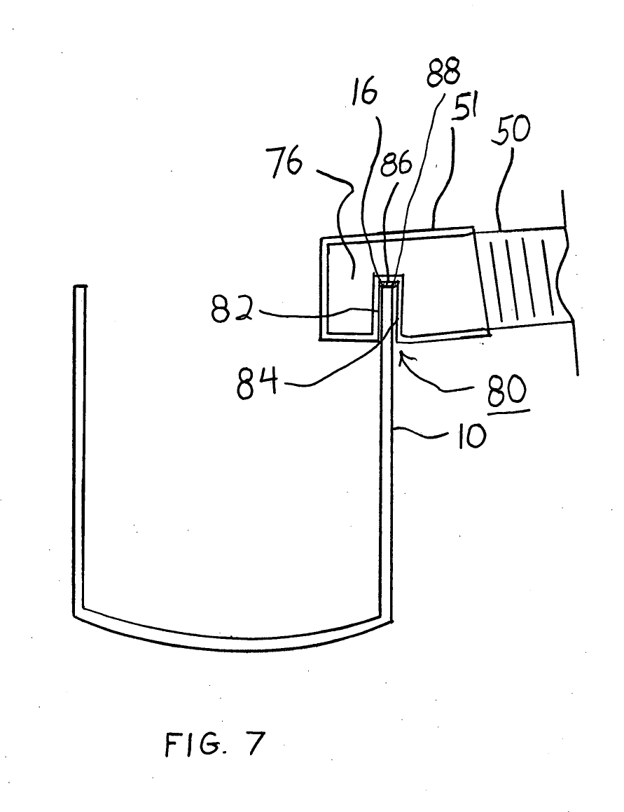

It is not necessary that the particulate collecting ring substantially match the perimeter of the mixing container top. Turning now to FIGS. 6 and 7, a particulate collector 70 is shaped and sized to communicate with only a portion of the mixing container top surface 16. In this embodiment, the down draft is greater due to the open top portion 17 of the mixing container 10.

Again, the particulate collector 70 includes openings 72 in its top surface 74 which communicate with an inner chamber 76. The inner chamber 76 then communicates with a vacuum port 51.

The vacuum hose 50 friction fits with the vacuum port 51 and creates a vacuum within the inner chamber 76. A downward draft is presented over the top of the mixing container 10, which draft is amplified because of the open top portion 17 of the mixing container 10.

The billowing dust is caught within the downward draft and is sucked through the openings 72 and into the vacuum container (not depicted in FIGS. 6 and 7).

An engagement member 80 includes an inner and outer flange member 82, 84, respectively, which are connected by a cross member 86. A sealing member 88 may be disposed under said cross member 86, and also on inner surfaces of the inner and outer flange 82, 84 to provide a seal and also a cushion fit.

As depicted in FIGS. 6 and 7, the engagement member 80 is only present where the inner chamber 76 communicates with the vacuum port 78. As such, the particulate collector 70 need not be an exact match for the upper perimeter of the mixing container 10. The particulate collector 70 includes a smaller effective radius than the radius of the mixing container.

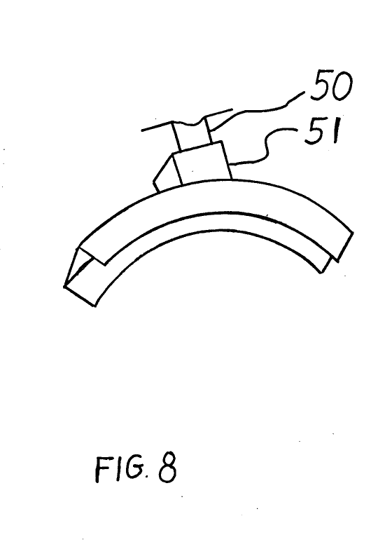

Turning now to FIG. 8, a particulate collector 90 includes a single opening 92 in which an inner chamber 94 is formed between an upper and lower protruding member 96, 98 respectively. The inner chamber 94 communicates with the vacuum port 51 and the particulates are then carried through the vacuum hose 50.

It may also be possible to have the particulate collection ring to include a larger diameter, or perimeter portion, than the mixing container by simply raising the particulate collection ring with respect to the engagement member so that the particulate collection ring fits entirely over the top of the mixing container.

The present invention may also be applied in various other fields such is in baking. Bakers often must mix powdery substances to form a paste like compound before baking. The mixing process therein also causes particulates to billow from the mixing container. Therefore, the present invention is suitable in other fields.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What I claim is:

1. A particulate collection apparatus for preventing billowing dust from spilling over a top of a mixing container during mixing, said apparatus comprising:
a vacuum having a dust collection container communicating therewith;
a particulate collection member which includes a vacuum port that communicates with said vacuum;
engagement means for engaging said particulate collection chamber to said mixing container; and
at least one opening within said particulate collection member which communicates with said particulate collection member and an open area of said mixing container.

2. The particulate collection apparatus of claim 1, wherein said at least one opening is disposed in a top surface of said particulate collection member.

3. The particulate collection apparatus of claim 1, wherein said at least one opening is disposed in an inner surface of said particulate collection member.

4. The particulate collection apparatus of claim 1, wherein said particulate collection member includes a portion thereof that is substantially shaped and sized to fit an upper perimeter of said mixing container.

5. The particulate collection apparatus of claim 1, wherein said particulate collection member includes a portion thereof that is substantially shaped and sized to fit a portion of an upper perimeter of said mixing container.

6. The particulate collection apparatus of claim 1, wherein said engagement means further a includes an inner and outer flange which are connected by a cross member, wherein said cross member fits over a top portion of said mixing container.

7. A mixing apparatus for mixing a powdery substance with a fluid to achieve a paste-like compound, said apparatus comprising:
a mixing container having an interior and exterior surface and an open top surface;
a particulate collection member which communicates with said open top surface;
engagement means to engage said particulate collection member with respect to at least a portion of said open top surface of said mixing container;
a channel disposed within said particulate collection member;
at least one opening in said particulate collection member which communicates with said channel; and
a vacuum means which communicates with said channel.

8. The mixing container of claim 7, wherein said at least one opening further includes a plurality of spaced openings through said particulate collection member.

9. The mixing container of claim 7, wherein said open top surface is circular.

10. The mixing container of claim 7, wherein said open top surface is rectangular.

11. The particulate collection apparatus of claim 7, wherein said at least one opening is disposed in a top surface of said particulate collection member.

12. The particulate collection apparatus of claim 7, wherein said at least one opening is disposed in an inner surface of said particulate collection member.

13. The particulate collection apparatus of claim 7, wherein said particulate collection member includes a portion thereof that is substantially shaped and sized to fit an upper perimeter of said mixing container.

14. The particulate collection apparatus of claim 7, wherein said particulate collection member includes a portion thereof that is substantially shaped and sized to fit a portion of an upper perimeter of said mixing container.

15. The particulate collection apparatus of claim 7, wherein said engagement means further a includes an inner and outer flange which are connected by a cross member, wherein said cross member fits over a top portion of said mixing container.

16. A method of mixing a mortar like substance with a fluid, said method comprising:
engaging a particulate collection member to at least a portion of a top member of a mixing container wherein said particulate collection member includes;
a particulate collection member which includes a vacuum port;
at least one opening disposed through said particulate collection member which communicates with said particulate collection member and an open area of said mixing container;
communicating a vacuum to said vacuum port of said particulate collection member;
pouring at least a portion of said mortar like substance within said container;
pouring at least a portion of said fluid within said container; and
mixing said at least a portion of said fluid with said at least a portion of said mortar like substance.
